(19) United States
(12) Patent Application Publication
(10) Pub. No.: US 2015/0369446 A1
(43) Pub. Date: Dec. 24, 2015

(54) LIGHTING DEVICE FOR A SHEET METAL AND SYSTEM HAVING THE SAME

(71) Applicants: Yu-Hung LIN, Taichung City (TW); Cheng-Tse CHANG, Changhua County (TW)

(72) Inventors: Yu-Hung LIN, Taichung City (TW); Cheng-Tse CHANG, Changhua County (TW)

(21) Appl. No.: 14/312,520

(22) Filed: Jun. 23, 2014

(51) Int. Cl. F21V 3/04; H05B 37/02; F21V 21/26; F21V 23/00; F21V 23/04

(52) U.S. Cl. CPC F21V 3/049; F21V 23/005; F21V 23/0435; F21V 21/26; H05B 37/0272; F21W 2131/40

(57) ABSTRACT

A lighting device for a sheet metal is provided, for emitting lights on a sheet metal. The lighting device includes: a bottom plate; a wireless remote module, including a signal receiver for receiving a wireless control signal; a plurality of lighting modules, for emitting a plurality of light colors; a cover body, covering the lighting modules and including a light translucent portion and a light opaque portion. The wireless remote module controls the lighting modules to emit light. The light from the lighting modules goes through the light translucent portion and projects a projection boundary defined by a common boundary constructed by the light translucent portion and the light opaque portion on the sheet metal. A lighting system for a sheet metal is also provided, including the lighting device described above and a support device. The lighting device is adjustably assembled with the support device.

### BACKGROUND OF THE INVENTION

1. Field of the Invention

The present invention relates to a lighting device, and more particularly to a lighting device for a sheet metal and system having the same.

2. Description of the Prior Art

It is ordinary to use an apparatus with fluorescent tubes to evaluate a reflective surface of an object (such as a sheet metal) on vehicles. This kind of apparatus is disclosed in U.S. Pat. No. 5,414,518. The apparatus comprises a main body member having a generally linear lower portion and a forwardly curved upper portion. The apparatus further comprises a plurality of elongated fluorescent tubes spaced equally and attached so as to be disposed horizontally (or vertically) to the main body member. When the apparatus is positioned adjacent to a stationary form with a reflective surface, images of the fluorescent tubes are produced in the reflective surface. A faulted surface will show erratically spaced and shaped reflections. The faulted surface requires reshaping until the patterns of the reflections are smooth and aesthetically acceptable.

However, there are different types of colors on the sheet metal of the different vehicles so that a corresponding different light color on the apparatus is also needed to evaluate the reflective surface. The apparatus with fluorescent tubes as described above has to change the light tubes if the apparatus needs to change the type of the color, and it is inconvenient. Besides, the fluorescent tubes need large power and cost much. The disadvantages are needed to be improved. The target of the present invention is also to make the apparatus smaller, save the cost and improve the working efficiency.

The present invention has arisen to mitigate and/or obviate the afore-described disadvantages.

### SUMMARY OF THE INVENTION

The primary object of the present invention is to provide a lighting device for a sheet metal, for producing projecting boundaries in the reflective surface and evaluating a situation of the reflective surface. It is fast for a repairman to find a position of a faulted surface, and it improves the working efficiency and reduces work time. The light device also provides a plurality of lighting colors to correspond different types of colors on different sheet metals, and it is selective and widely used. The lighting colors can be changed via a wireless remote system, and it is rapid and convenient. To achieve the above object, a lighting device for a sheet metal is provided, for emitting a light on a sheet metal. The lighting device includes: a bottom plate; a wireless remote module, including a wireless receiver and for receiving a wireless control signal from outside; a plurality of lighting modules, disposed on the bottom plate, controllable to electrically connect with the wireless remote system and for producing a plurality of light colors; a cover body, fixedly assembled with the bottom plate, covering on the lighting modules and including a light translucent portion and a light opaque portion adjacent to the light translucent portion. The light translucent portion has a foggy surface. The wireless remote module receives the wireless control signal and controls the lighting modules to emit light. The light from the lighting modules goes through the light translucent portion and project a projection boundary defined by a common boundary constructed by the light translucent portion and the light opaque portion on the sheet metal.

A lighting system for a sheet metal is also provided, including the lighting device as described above and a support device. The lighting device is adjustably assembled with the support device.

### BRIEF DESCRIPTION OF THE DRAWINGS

FIG. 1 is a perspective drawing of a lighting device in accordance with a preferable embodiment of the present invention;

FIG. 2 is a breakdown drawing of the lighting device in accordance with the preferable embodiment of the present invention;

FIG. 3 is a perspective drawing of the lighting device in accordance with the preferable embodiment of the present invention;

FIG. 4 is a perspective drawing of the lighting device in accordance with the preferable embodiment of the present invention in use;

FIG. 5 is a perspective drawing of the lighting device in accordance with another embodiment of the present invention;

FIG. 6 is a perspective drawing of the lighting device in accordance with the other embodiment of the present invention in use.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

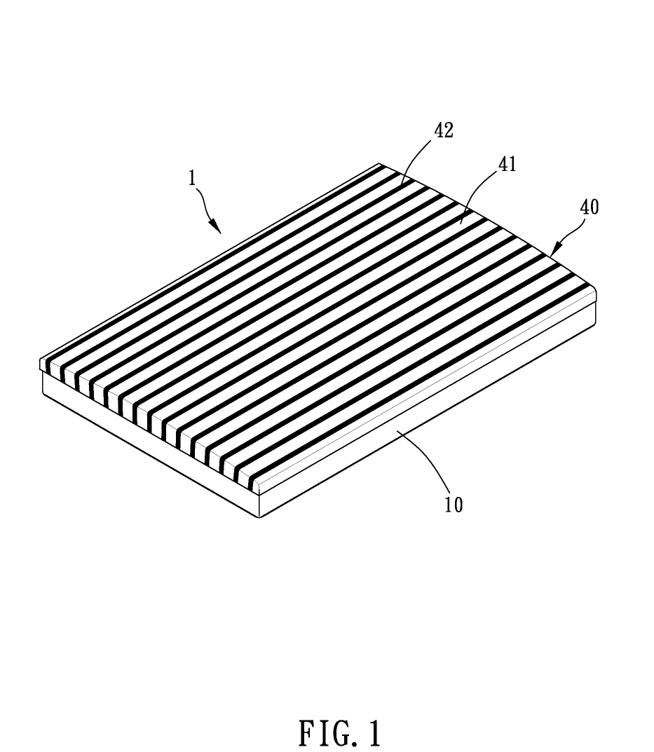

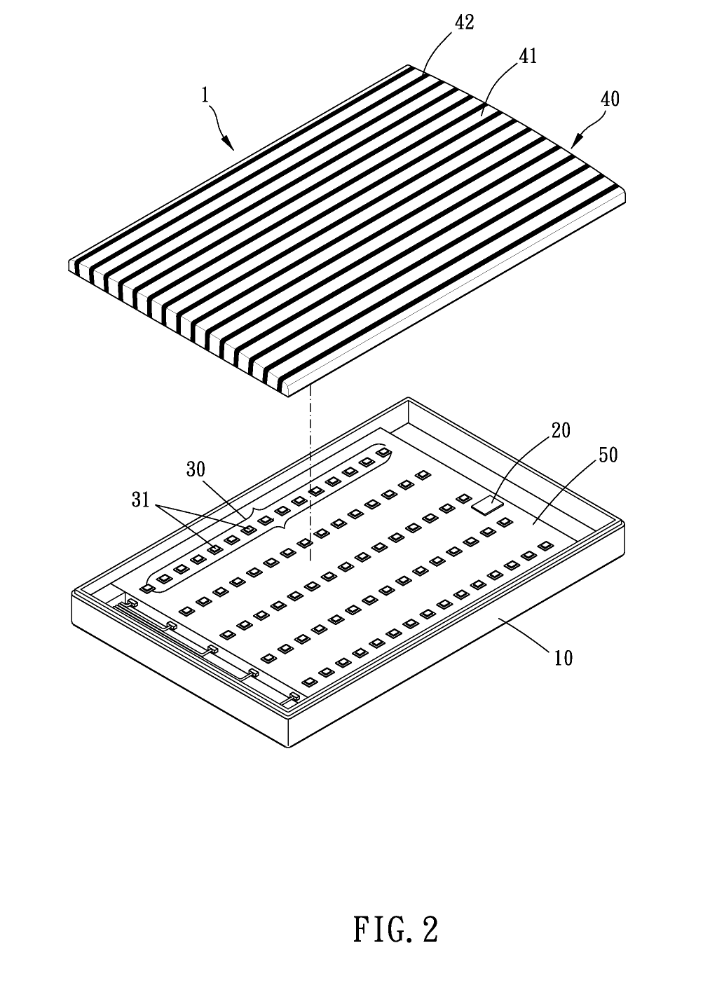

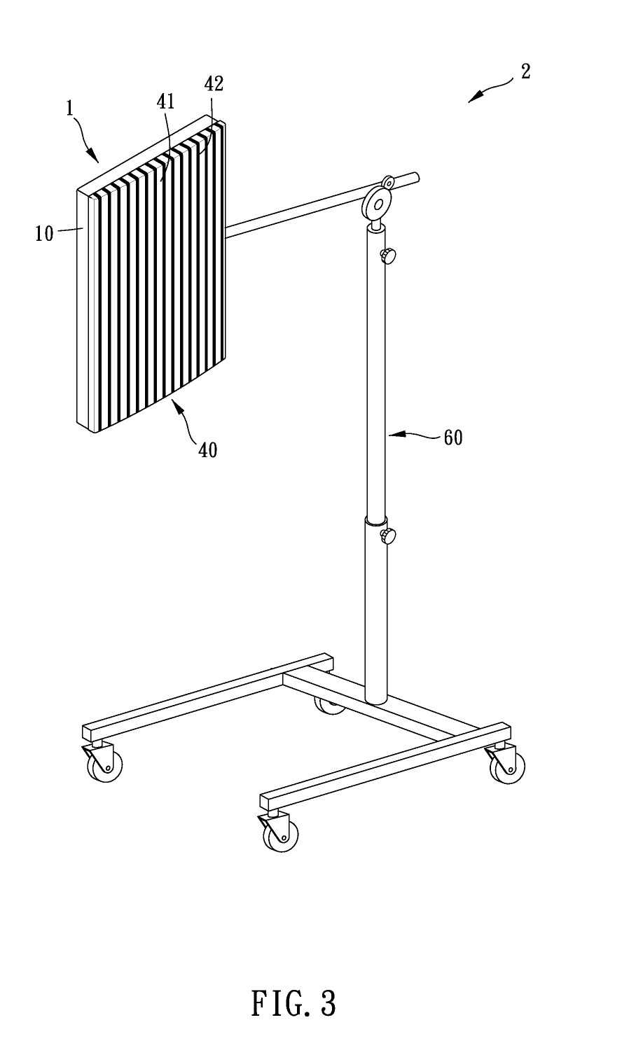

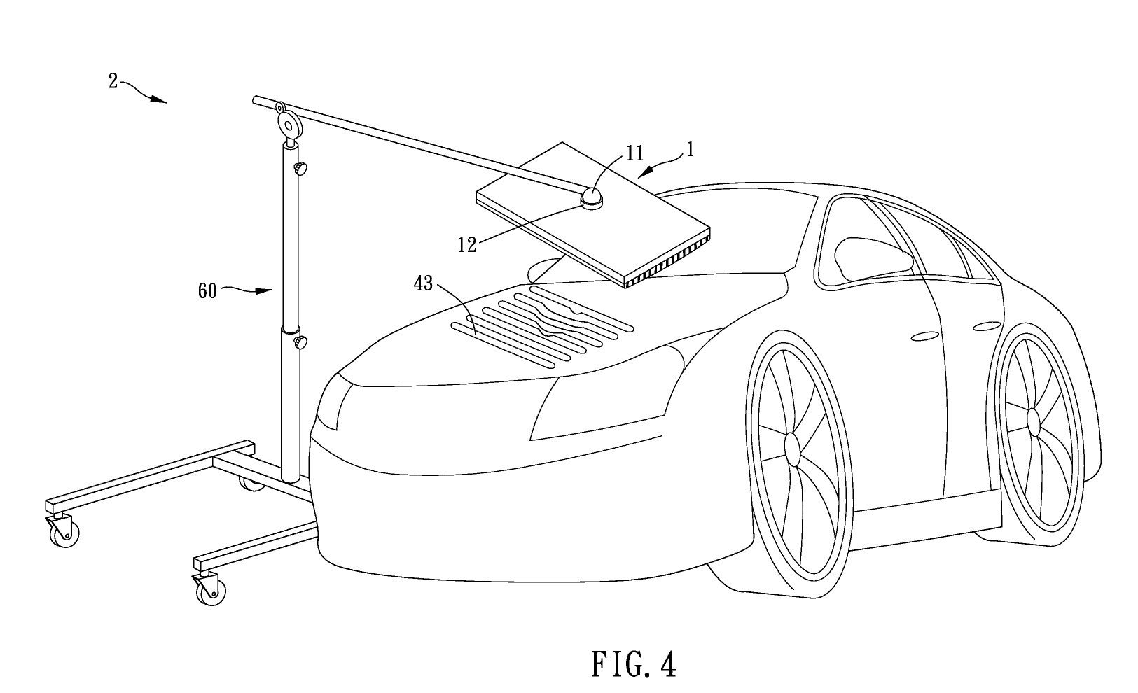

Referring to FIGS. 1-4, a lighting device 1 for a sheet metal in accordance with a preferred embodiment of the present invention is for emitting a light on the sheet metal and comprises a bottom plate 10, a wireless remote module 20, a plurality of lighting modules 30 and a cover body 40.

The bottom plate 10 includes a circuit board 50, and the circuit board 50 includes a circuit. Practically, the circuit board 50 is a printed circuit board (PCB) and has a predetermined shape. The circuit board 50 is cut in shapes such as circle, ellipse, square, rectangle, strand, polygon, irregular or other shapes. The circuit board 50 is for laying with numerous electrical parts and to form the circuit having a predetermined electrical function. The bottom plate 10 is such as a metal member, and the bottom plate 10 can have a strong structure and protect the circuit board 50 when the circuit board 50 is assembled inside.

The wireless remote module 20 and the lighting modules 30 are disposed on the bottom plate 10, and the wireless remote module 20 and the lighting modules 30 are electrically connected with the circuit. The wireless remote module 20 includes a wireless receiver and is for receiving a wireless signal from outside. The wireless remote module 20 uses an electric-magnetic wave as the wireless signal and transmits or receives it. Conveniently, the wireless remote module 20 needs no electrical cables to transmit or receive signal and it avoids the inconvenience may come from the electrical cables, such that the electrical cable is short in circuit or short in length so that the signal is unable to transmit or receive and delays the work. The lighting modules 30 selectively produce a plurality of predetermined lighting colors and are controllably connected with the wireless remote module 20. Moreover, the lighting modules 30 include a plurality of LED members 31 (or lamps, other lighting members). The LED members 31 are disposed on the circuit board 50 via such as SMT method. The LED members 31 can be laid sectioningly according to different lighting colors. For example, the LED members 31 can be laid in shapes such as circle, rectangular, strand or other shapes, and the LED members 31 can also be interlaced with each other and spaced-apart laid. The lighting modules 30 can changeably produce the predetermined lighting colors by the control of the wireless remote system 20.

The cover body 40 is fixedly assembled with the bottom plate 10 and covers the lighting modules 30. The wireless remote module 20 is disposed inside the lighting device 1 and between the cover body 40 and the bottom plate 10. For example, the lighting modules 30 and the wireless remote module 20 can face the cover body 40. The cover body 40 includes a light translucent portion 41 and a light opaque portion 42 adjacent to the light translucent portion 41. The light translucent portion 41 has a foggy surface. The foggy surface is formed via a mould processed by sandblasting or texturing. Preferably, the foggy surface diffuses a light going through the foggy surface. The light opaque portion 42 is formed with printed ink or opaque glue layers and stops a light entirely. In the present embodiment, the light opaque portion 42 includes a plurality of spaced opaque areas substantially parallel to each other.

Practically, the wireless remote module 20 receives the wireless control signal and controls the lighting modules 30 to emit light. For example, a user can use a wireless transmitter to transmit a control signal to the wireless receiver. The wireless remote module 20 controls the lighting modules 30 to produce the predetermined light colors. And the light emitting from the lighting modules 30 goes through the light translucent portion 41 and projects a projection boundary 43 defined by a common boundary constructed by the light translucent portion 41 and the light opaque portion 42 on the sheet metal. In the present embodiment, a plurality of strand-shaped projection boundaries 43 are formed. Moreover, the projection boundaries 43 evaluate the reflective surface of the sheet metal, for example, the projection boundaries 43 are unequally spaced-apart, twisted or deformed on a faulted surface, and it helps a repairman to find the position of the faulted surface on the sheet metal in a very short time. The repairman can work on the faulted surface and reshape it. It increases the work efficiency. Conveniently, the lighting modules 30 can also provide a plurality of light colors for corresponding the color of the sheet metal, and it is selective and widely used. The lighting modules 30 can be conveniently controlled by the wireless remote module 20 and change the light color rapidly, and it is convenient.

Moreover, the bottom plate 10 further includes an assembling mechanism 12 for assembling with an assembling foundation 11. In the present embodiment, the assembling foundation 11 is such as a universal joint. The assembling mechanism 12 is such as a connecting portion for universal joint. In the other embodiments, the assembling foundation 11 can also include for example at least one through hole for screw, and the assembling mechanism 12 can include for example at least one threaded hole. The assembling foundation 11 and the assembling mechanism 12 can be assembled with each other through at least one screw penetrating through the assembling foundation 11 and screws with the assembling mechanism 12. Moreover, the lighting device 1 is applied to a lighting system 2 for a sheet metal, and the lighting system 2 includes the lighting device 1 as described above and a support device 60 for assembling with the lighting device 1. The lighting system 2 is used for example in a garage, and a repairman can assemble the lighting device 1 on the support device 60. The support device 60 can be set up on the ground and moved close to a repairing vehicle. Preferably, the lighting device 1 is adjustably connected with the support device 60, and the repairman can conveniently adjust the lighting device 1 to light the reflective surface of the sheet metal on the vehicle and repair it.

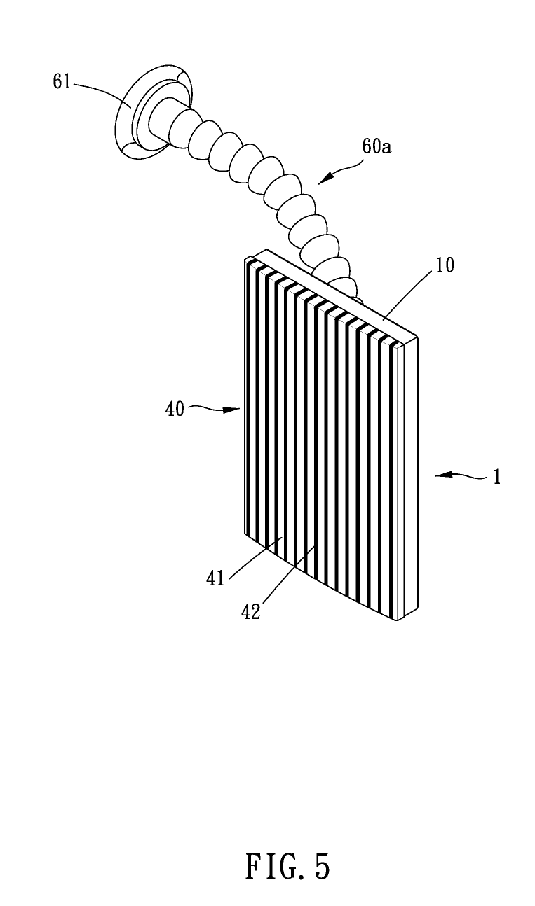

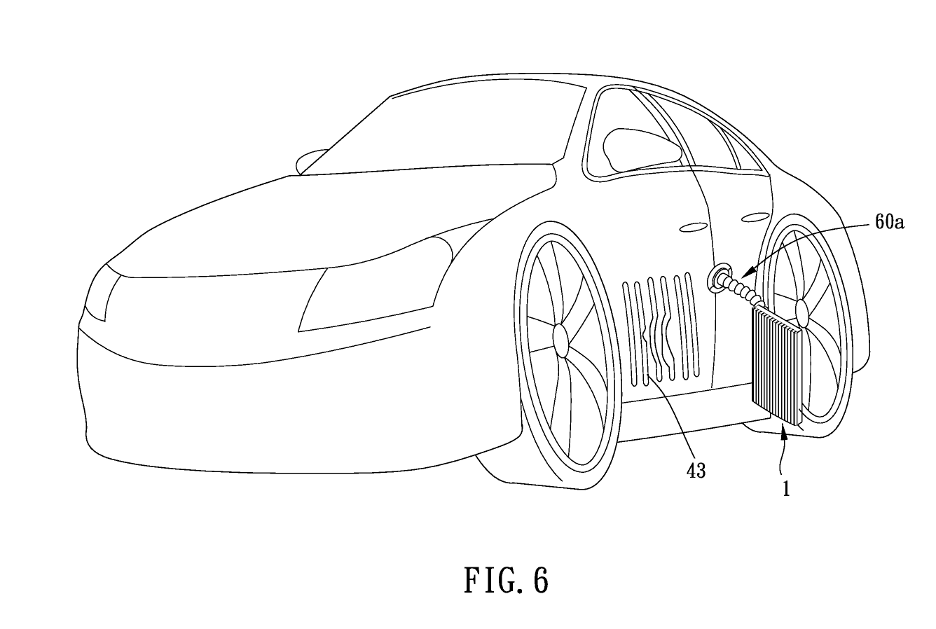

Referring to FIGS. 5-6, in another embodiment, a support device 60a includes an adjustable arm. Conveniently, the support device 60a is formed with a suction cup device 61 on an end, and the suction cup device 61 is for fixing on a surface of a glass or a sheet metal. The support device 60a has characteristics of retaining in a specific direction and position as it is adjusted. The repairman can assemble the lighting device 1 on the support device 60a and repair the sheet metal with the lighting device 1.

As a conclusion, the lighting device for a sheet metal is for producing projecting boundaries in the reflective surface and evaluating a situation of the reflective surface. It is fast for a repairman to find a position of a faulted surface, and it improves the working efficiency and reduces work time. The light device also provides a plurality of lighting colors to correspond different types of colors on different sheet metals, and it is selective and widely used. The lighting colors can be changed via a wireless remote system, and it is rapid and convenient.

While we have shown and described various embodiments in accordance with the present invention, it should be clear to those skilled in the art that further embodiments may be made without departing from the scope of the present invention.

What is claimed is:

1. A lighting device for a sheet metal, for emitting a light on the sheet metal, comprising:
a bottom plate;
a wireless remote module, including a wireless receiver, for receiving a wireless control signal from outside;
a plurality of lighting modules, disposed on the bottom plate, controllably connected with the wireless remote module electrically, for selectively producing a plurality of predetermined light colors;
a cover body, fixedly assembled with the bottom plate, covering the lighting modules, including a light translucent portion and a light opaque portion adjacent to the light translucent portion, the light translucent portion having a foggy surface, the wireless remote module receiving the wireless control signal and controlling the lighting modules to emit light, the light from the lighting modules going through the light translucent portion and projecting a projection boundary defined by a common boundary constructed by the light translucent portion and the light opaque portion on the sheet metal.

2. The lighting device as claimed in claim 1, wherein the bottom plate includes a circuit board, the circuit board includes a circuit, and the wireless remote module and the lighting modules are connected with the circuit electrically.

3. The lighting device as claimed in claim 1, wherein the foggy surface is formed via a mould processed by sandblasting or texturing.

4. The lighting device as claimed in claim 1, wherein the light opaque portion is formed with printed ink or opaque glue layers.

5. The lighting device as claimed in claim 1, wherein the light opaque portion includes a plurality of spaced opaque areas substantially parallel to each other.

6. The lighting device as claimed in claim 1, wherein the wireless remote module is disposed inside the lighting device and between the cover body and the bottom plate.

7. The lighting device as claimed in claim 1, wherein the bottom plate is further formed with an assembling mechanism for assembling with an assembling foundation.

8. A lighting system for a sheet metal, including the lighting device as described in claim 1, further including a support device, the lighting device adjustably connected with the support device.

9. The system as claimed in claim 8, wherein the support device includes an adjustable arm, and the adjustable arm has characteristics of retaining in a specific direction and position as it is adjusted.
